(19) United States
(12) Patent Application Publication
(10) Pub. No.: US 2019/0209421 A1
(43) Pub. Date: Jul. 11, 2019

(54) EXPANDABLE CUSHION MASSAGE DEVICE AND METHOD FOR CONTROLLING THE SAME

(71) Applicant: Huizhou Flex Smart Furniture Co., Ltd., Huizhou City, (CN)

(72) Inventor: Guohong Zeng, Huizhou City (CN)

(21) Appl. No.: 15/574,320

(22) PCT Filed: Jun. 16, 2017
(86) PCT No.: PCT/CN2017/088795

§ 371 Date: Nov. 15, 2017

(30) Foreign Application Priority Data
Jan. 23, 2017 (CN) 201710055922.6

(51) Int. Cl. A61H 9/00

(52) U.S. Cl. CPC A61H 9/0078; A61H 2201/1238; A61H 2201/0207; A61H 2201/5071; A61H 2201/1409; A61H 2201/1659; A61H 2201/1669; A61H 2201/5007; A61H 2201/5082

(57) ABSTRACT

Provided are an expandable cushion massage device and a method for controlling the same. The expandable cushion massage device includes an expandable cushion layer, a massage layer, a valve and a multi-purpose pump. The expandable cushion layer includes a first expandable bag and a second expandable bag, with the first expandable bag and the second expandable bag provided at upper and lower ends of the massage layer respectively, and the first expandable bag and the second expandable bag connected with the multi-purpose pump via the valve. The expandable cushion massage device which not only can be used as a massage apparatus, but also can be used as an ordinary bed or chair, assures the comfortableness when used as an ordinary bed or chair, improves user experience, and achieve the object of implementing massage fitness and rest on the same apparatus.

### REFERENCE TO RELATED APPLICATION

The present application claims priority to PCT Patent Application No. PCT/CN2017/088795, filed Jun. 16, 2017, which claims priority to Chinese Patent Application No. 201710055922.6, filed with the Chinese Patent Office on Jan. 23, 2017, the contents of which is incorporated herein by reference in its entirety.

### FIELD OF THE INVENTION

The present application relates to the technical field of health care apparatuses, and particularly to an expandable cushion massage device and a method for controlling the same.

### BACKGROUND OF THE INVENTION

Massage is a method in which manipulations is performed on specified parts of human body surface on the theoretical basis of theories of viscera and meridians of traditional Chinese medicine in combination with anatomic and pathological diagnosis in Western medicine, so as to adjust the physiological and pathological condition of the human body, for achieving the purpose of physiotherapy. Thus, from a view of nature, the massage is a kind of physical treatment method. From a view of the treatment, the massage can be classified into therapeutic massage, sports massage and medical massage.

In recent years, there has been always a strong for massage apparatus products from China in international markets, and improvements of the manufacturing level in China also provide basic guarantee for the manufacture of massage apparatuses from China, thus the worldwide production capacity is gradually transferred to China, which makes China become the manufacturing center for massage appliances of the whole world.

Massage equipment, which is a general term of instruments for massaging the whole body or respective body parts of human beings, includes equipment types such as a massage chair, a massage couch, a massage bath room and a massager. Among these, the massage chair and the massage couch perform a relatively full range of body massage, while the massager is an apparatus performing massage for a certain part of the body. Massage equipment is a new generation of health care equipment that is researched and developed based on physics, bionics, electrobiology, traditional Chinese medical and years of clinical practices. With the continuous improvement of modern living standards, as well as the continuous renewal of people's life philosophy, massage equipment has become a symbol of health investment and fashionable lifestyle, and is accepted by more and more people.

The massage couches, also known as shiatsu couches, beauty beds, physiotherapy couches, back rubbing beds and the like, are widely used in places such as foot massage shops, beauty salons, physiotherapy hospitals and bathing places and so on. Massage couches are classified as follows:

1. According to materials, the massage couches may be classified into a solid-wood massage couch, an iron-stand massage couch, an aluminum alloy massage couch, a stainless steel massage couch of, an acrylic massage couch and the like;

2. According to characteristics, the massage couches may be classified into foldable massage couches and massage couches which cannot be folded;

3. According to uses, the massage couches may be classified into medical massage couches (massage couches for traditional Chinese medical massage), physiotherapeutic massage couches (health care massage couches), foot massage couches (foot bath massage couches), SPA massage couches (sauna massage couches), massage couches for hair washing, massage couches for beauty and body care, and the like;

4. According to styles, the massage couches may be classified into Chinese massage couches, Japanese massage couches, Thai massage couches and the like.

In order to achieve massaging effect, massage parts contacting human body, of the massage apparatus such as the massage couches or the massage chairs which are available in current market, are relatively rigid, such that the human body can be pressed or massaged by other manipulations when the massage parts work. However, considering the comfortableness, a user will only use the massage apparatus for massage, and will no longer use the massage apparatus when the massage is finished, that is, when the massaging parts stop working. Therefore, the existing massage apparatus has single function, which is not conducive to the improvement of user experience.

### SUMMARY OF THE INVENTION

In view of this, the present invention provides an expandable cushion massage device and a method for controlling the same, so as to alleviate the above-mentioned problems.

In a first aspect, an embodiment of the present invention provides an expandable cushion massage device which includes an expandable cushion layer, a massage layer, a valve and a multi-purpose pump. The expandable cushion layer includes a first expandable bag and a second expandable bag, with the first expandable bag and the second expandable bag being provided at an upper end and a lower end of the massage layer, respectively. The first expandable bag and the second expandable bag are in connection with the multi-purpose pump via the valve. When the massage layer is in an operating state, the second expandable bag is filled with fluid through the multi-purpose pump and is expanded, and the first expandable bag is evacuated via the valve to completely discharge fluid. When the massage layer is in an inactive state, the first expandable bag is filled with the fluid through the multi-purpose pump and is expanded, and the second expandable bag is evacuated via the valve to completely discharge fluid.

Further, the valve includes a first valve and a second valve. The first valve is in connection with the first expandable bag, and the second valve is in connection with the second expandable bag.

Further, the expandable cushion massage device further includes a first pressure sensor and a second pressure sensor. The first pressure sensor is in connection with the first expandable bag, and the second pressure sensor is in connection with the second expandable bag.

Further, the first expandable bag further includes a heating layer, and the heating layer is provided on the first expandable bag and attached to the first expandable bag.

Further, the heating layer further includes a temperature sensor provided at a side of the heating layer.

Further, the first expandable bag further includes a fluid inlet provided at a side of the first expandable bag.

Further, the first expandable bag further includes a fluid outlet provided at a side of the first expandable bag.

Further, the fluid outlet further includes an output pump provided at an outlet end of the fluid outlet.

Further, the expandable cushion massage device further includes a central control device, a first pressure sensor in connection with the first expandable bag and a second pressure sensor in connection with the second expandable bag. The central control device includes a processing module, an acquisition module and an output module. The acquisition module is configured to acquire data from the temperature sensor and the pressure sensor. The processing module is configured to process and identify the data acquired by the acquisition module. The output module is configured to output the data processed and identified by the processing module.

Further, the central control device further includes a temperature control module, a multi-purpose pump control module and a valve control module. The temperature control module is configured to receive a first instruction outputted by the output module and control the heating layer according to the first instruction. The multi-purpose pump control module is configured to receive a second instruction outputted by the output module and control the multi-purpose pump according to the second instruction. The valve control module is configured to receive a third instruction outputted by the output module and control the first valve and the second valve according to the third instruction.

Further, the massage layer includes a main massaging device, a moving device and a floating device. The floating device is provided at a lower end of the main massaging device and configured to make the main massaging device float up and down. The moving device is provided at a lower end of the floating device and configured to make the main massaging device move back and forth in a preset rail.

In a second aspect, an embodiment of the present invention further provides an expandable cushion massage device, which includes an expandable cushion layer, a massage layer, a valve and a multi-purpose pump. The expandable cushion layer includes a first expandable bag, and the first expandable bag is provided above the massage layer. The first expandable bag is in connection with the multi-purpose pump via the valve. In a situation where the massage layer is in an operating state, the first expandable bag is evacuated via the valve to completely discharge fluid, leading to an empty state. In a situation where the massage layer is in an inactive state, the first expandable bag is filled with fluid via the multi-purpose pump, leading to a filled state.

In a third aspect, an embodiment of the present invention further provides a method for controlling an expandable cushion massage device. The expandable cushion massage device includes an expandable cushion layer, a massage layer, a valve and a multi-purpose pump. The expandable cushion layer includes a first expandable bag and a second expandable bag, with the first expandable bag being arranged above the massage layer and the second expandable bag being arranged below the massage layer. The first expandable bag and the second expandable bag are both in connection with the multi-purpose pump via the valve. The method includes: controlling the multi-purpose pump to fill the second expandable bag with fluid to form a filled state where the second expandable bag is full of the fluid, and controlling the valve to evacuate the fluid within the first expandable bag to form an empty state, in a situation where the massage layer is in an operating state; and controlling the multi-purpose pump to fill the first expandable bag with fluid to form a filled state where the first expandable bag is full of the fluid, and controlling the valve to evacuate the fluid within the second expandable bag to form an empty state, in a situation where the massage layer is in an inactive state.

Compared with the existing massage apparatuses such as massage couches or massage chairs, the expandable cushion massage device provided in the present embodiment is provided with the first expandable bag and the second expandable bag configured for buffering at upper and lower ends of the massage layer, respectively. The amounts of fluid within the first expandable bag and the second expandable bag are adjusted by switching between the operating state and the inactive state of the massage layer. When the massage layer is in the operating state, the second expandable bag is in the filled state, while the first expandable bag is in the empty state; and when the massage layer is in the inactive state, the second expandable bag is in the empty state, while the first expandable bag is in the filled state. By switching between the filled state and the empty state of the first expandable bag and the second expandable bag, the expandable cushion massage device provided in the present embodiment is enabled to not only serve as a massage apparatus with a massage function, but also serve as a bed or a chair providing a relatively comfortable use for users. The expandable massage device provided in the present embodiment realizes a function enabling the device to be multi-purpose, and achieves the object of implementing massage fitness and rest on a same apparatus, which are convenient for the user and improve user experience.

When the user uses the expandable cushion massage device provided in the present embodiment for massage, the massage layer is in the working state, the first expandable bag is in the empty state and the second expandable bag is in the filled state. The second expandable bag in the filled state raises the massage layer, such that the massage layer acts on a certain body part of the user and massages the certain body part.

When the massaging process for the user is finished, the massage layer stops working, and the apparatus will evacuate the fluid within the second expandable bag, while the first expandable bag is filled with fluid, that is to say, the second expandable bag is made to be in the empty state and the first expandable bag is made to be in the filled state. At the moment, the expandable cushion massage device can be used as a piece of furniture or equipment such as a bed or a chair. As the second expandable bag is in the empty state and the first expandable bag is in the filled state, it can be avoided that the massage layer directly acts on the human body, which effectively assures the comfortable sensation when the user uses the expandable cushion massage device as a bed or a chair.

Further, the expandable cushion massage device provided in the present embodiment is equipped with two valves, which are the first valve in connection with the first expandable bag and the second valve in connection with the second expandable bag, respectively. During the operating process of the apparatus, the two valves are connected with and cooperate with the multi-purpose pump, so as to control flowing directions of the fluid within the first expandable bag and the second expandable bag and control the fluid within the first expandable bag and the second expandable bag to flow or be blocked. When the massage layer is in the working state, the multi-purpose pump is actuated, and the second valve opens to allow the fluid to enter the second expandable bag, such that the second expandable bag is in the filled state, and the first valve is closed and at the same time, the first expandable bag is evacuated via the valve to completely discharge fluid, such that the first expandable bag is in the empty state. When the massage layer is in the in active state, the second valve is closed and at the same time, the second expandable bag is evacuated via the valve to completely discharge fluid, such that the second expandable bag is in the empty state, while the first valve opens to allow the fluid to enter the first expandable bag, such that the first expandable bag is in the filled state. The state of the massage layer is switched between the working state and the inactive state, such that states of the first expandable bag and the second expandable bag are correspondingly switched between the filled state and the empty state, thereby the overall height of the massage apparatus would not be affected no matter whether the massage apparatus is in the working state or inactive state; in the meantime, the massage apparatus is enabled to have certain elasticity when it is in an inactive state, which assures the comfortableness when the user uses the massage apparatus as a bed or a chair.

Further, the first expandable bag and the second expandable bag are each provided with a pressure sensor, namely a first pressure sensor and a second pressure sensor, respectively. The function of the pressure sensor is to monitor the pressure in the expandable bag when the fluid is fed in; at the same time, the actuation and stop of the multi-purpose pump is controlled by the pressure sensor, specifically, when the pressure within the expandable bag reaches a predetermined safety threshold, the valve corresponding to the expandable bag is closed and in the meantime the multi-purpose pump is switched off, thus completing the process of feeding fluid into the expandable bag.

Further, a heating layer is further arranged on the first expandable bag in the present embodiment. The heating layer can realize the effect of heating through energization, which makes the user feel the heating effect of the massage apparatus while experiencing the massage function of the apparatus, so as to improve the user experience for the expandable cushion massage device.

Further, in the present embodiment, the heating layer is further provided with a temperature sensor. The heating temperature achieved by the heating layer can be monitored by the temperature sensor, and a range of the heating achieved by the heating layer can be controlled by setting a lowest and a highest threshold of the temperature of the heating layer.

Further, the expandable cushion massage device provided in the present embodiment is provided with a fluid inlet and a fluid outlet, configured for manually feeding the fluid and manually discharging the fluid respectively. The above-mentioned fluid may be gas or a liquid. If the gas is used, the expandable bag can be inflated and deflated by the multi-purpose pump; and if the liquid, e.g. water, is used, the flowing direction of water within the expandable bag can be guided by the multi-purpose pump. When the expandable bag needs to be manually evacuated to discharge the fluid or the expandable bag needs to be washed, manual operations shall be performed via the fluid inlet and the fluid outlet.

Further, the expandable massage device provided in the present embodiment is provided with a central control device. The central control device includes a processing module, an acquisition module, an output module, a temperature control module, a multi-purpose pump control module and a valve control module. After that the acquisition module acquires data sent back by a sensor, the processing module processes the data, and a corresponding control instruction is outputted by the output module to the temperature control module, the multi-purpose pump control module and the valve control module, so as to control corresponding components.

Further, the massage layer in the present embodiment includes a main massaging device, a moving device and a floating device. The moving device and the floating device are configured to drive the main massaging device to move in a predetermined direction and float up and down at the same time, thereby a good massaging effect is achieved.

### BRIEF DESCRIPTION OF THE DRAWINGS

It shall be understood that the following drawings merely show some embodiments of the present application, and thus should not be deemed as limiting the scope. For a person skilled in the art, other relevant drawings could be obtained according to these figures without any inventive efforts.

FIG. 1 is a schematic structural view showing, from a side viewing angle, an expandable cushion massage device disclosed in an embodiment of the present application;

FIG. 2 is a schematic perspective structural view of an expandable cushion massage device disclosed in an embodiment of the present application; and

FIG. 3 is a schematic module view of a central control device disclosed in an embodiment of the present application.

### REFERENCE SIGNS

| Term | Number |
|---|---|
| Expandable cushion layer | 1 |
| First expandable bag | 11 |
| Heating layer | 111 |
| Temperature sensor | 1111 |
| Fluid inlet | 112 |
| Fluid outlet | 113 |
| Output pump | 1131 |
| Second expandable bag | 12 |
| Massage layer | 2 |
| Main massaging device | 21 |
| Moving device | 22 |
| Floating device | 23 |
| Valve | 3 |
| First valve | 31 |
| Second valve | 32 |
| Multi-purpose pump | 4 |
| First pressure sensor | 5 |
| Second pressure sensor | 6 |
| Central control device | 7 |
| Processing module | 71 |
| Acquisition module | 72 |
| Output module | 73 |
| Temperature control module | 74 |
| Multi-purpose pump control module | 75 |
| Valve control module | 76 |

### DETAILED DESCRIPTION OF THE INVENTION

In order to more clearly describe the technical solutions of the present application, the claims of the present application will be further described in detail below with reference to specific embodiments and figures. It could be understood that the following figures merely show certain embodiments of the present application and thus should not be deemed as limiting the scope. Any modifications of finite times made by any person within the scope claimed by the claims of the present application still fall within the scope of the claims of the present application.

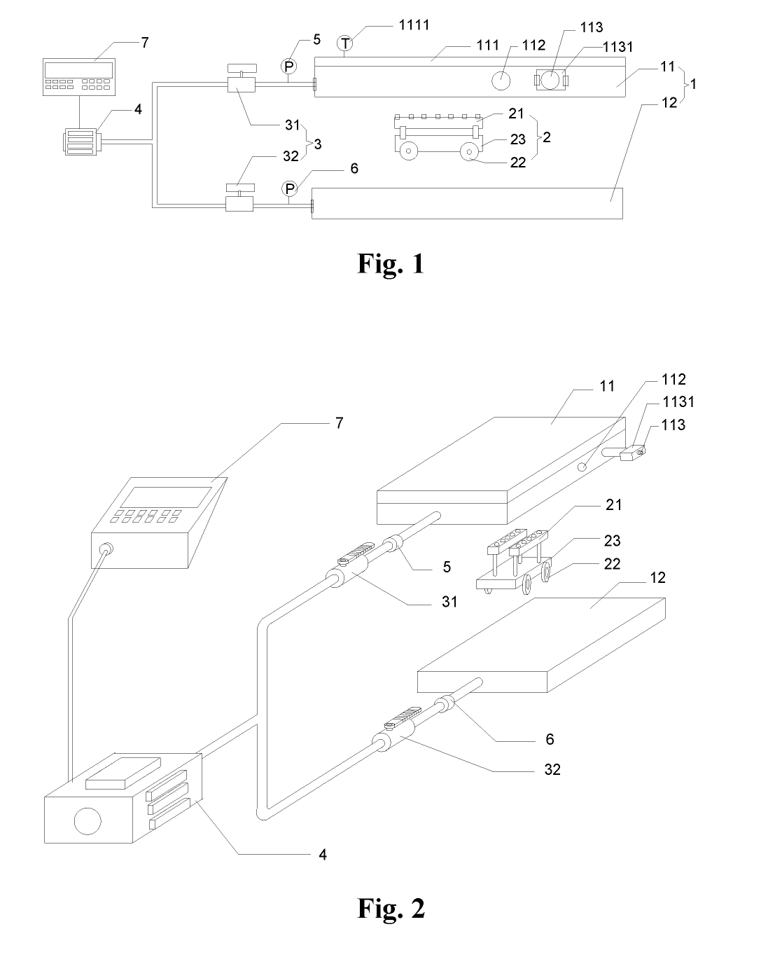

As shown in FIG. 1, the present embodiment provides an expandable cushion massage device which includes an expandable cushion layer 1, a massage layer 2, a valve 3 and a multi-purpose pump 4.

The expandable cushion layer 1 includes a first expandable bag 11 and a second expandable bag 12. The first expandable bag 11 and the second expandable bag 12 are arranged on an upper end and a lower end of the massage layer 2, respectively. That is to say, the first expandable bag 11 is arranged above the massage layer 2, and the second expandable bag 12 is arranged below the massage layer 2. Specifically, as shown in FIG. 1, the first expandable bag 11, the massage layer 2 and the second expandable bag 12 are arranged in a way of overlapping each other, in this way, the massage layer 2 is sandwiched between the first expandable bag 11 and the second expandable bag 12. It shall be clarified that assuming that a surface of the expandable cushion massage device in contact with the human body is a contact surface when the user users the present expandable cushion massage device, the “above” in “above the massage layer 2” refers to a direction towards the contact surface with the massage layer 2 as reference, while the “below” in “below the massage layer 2” refers to a direction away from the contact surface with the massage layer 2 as reference.

The first expandable bag 11 and the second expandable bag 12 are in connection with the multi-purpose pump 4 via the valve 3. When the massage layer 2 is in an operating state, the second expandable bag 12 is filled with fluid via the multi-purpose pump 4 and is expanded, and the first expandable bag 11 is evacuated via the valve 3 to completely discharge fluid. That is to say, at the moment, the second expandable bag 12 is in a filled state and the first expandable bag 11 is in an empty state. When the massage layer 2 is in an inactive state, the first expandable bag 11 is filled with the fluid via the multi-purpose pump 4 and is expanded, and the second expandable bag 12 is evacuated via the valve 3 to completely discharge fluid. That is to say, at the moment, the first expandable bag 11 is in the filled state and the second expandable bag 12 is in the empty state.

As mentioned above, the expandable cushion massage device provided in the present embodiment is equipped with the first expandable bag 11 and the second expandable bag 12 configured for buffering at the upper and lower ends of the massage layer 2. The amounts of fluid within the first expandable bag 11 and the second expandable bag 12 are adjusted by switching between the operating state and the inactive state of the massage layer 2. When the expandable cushion massage device is in the operating state, the second expandable bag 12 is filled while the first expandable bag 11 is evacuated, and when the expandable cushion massage device is in the inactive state or in a shutdown state, the second expandable bag 12 is evacuated while the first expandable bag 11 is filled.

The expandable cushion massage device can be switched between a state of being used as a massage apparatus and a state of being used as an ordinary bed or an ordinary chair, by switching between the filled state and the empty state of the expandable cushion layer 1. When a user uses the expandable cushion massage device provided in the present embodiment to perform massage, that is, when the massage layer 2 is in the operating state, the first expandable bag 11 is in the empty state and the second expandable bag 12 is in the filled state. The second expandable bag 12 in the filled state raises the massage layer 2, such that the massage layer 2 acts on a certain body part of the user and massages the certain body part, and it is conducive to compensate a height difference of the expandable cushion massage device caused by the state switching of the first expandable bag 11.

When the massaging process for the use is finished, the massage layer 2 is made to be inactive. At the moment, the apparatus will evacuate the fluid within the second expandable bag 12, while the first expandable bag 11 is filled with the fluid, that is to say, the first expandable bag 11 is in the filled state and the second expandable bag 12 is in the empty state. At this moment, the present expandable cushion massage device may be used as a piece of furniture or equipment such as an ordinary bed or chair. In the meantime, as the first expandable bag 11 is filled with the fluid, it can be avoided that the relatively rigid massage layer 2 directly acts on the human body, such that the expandable cushion massage device has an elasticity similar to that of a bed mattress or a chair cushion, which effectively assures the comfortable sensation when the user uses the expandable cushion massage device as a bed or a chair.

In the present embodiment, the present expandable cushion massage device is enabled to be switched between a state of being used as a massage apparatus and a state of being used as an ordinary bed or chair, by providing with the first expandable bag 11 and the second expandable bag 12 and controlling the first expandable bag 11 and the second expandable bag 12 to be switched between the filled state and the empty state. Moreover, the comfortableness can be effectively assured when the massage device is used as the ordinary bed or chair. Thus, the expandable massage device provided in the present embodiment realizes a function enabling the device to be multi-purpose, improves the comfortable level so as to improve the user experience, and achieves the object of implementing massage fitness and rest on a same apparatus.

It shall be clarified that thicknesses of the first expandable bag 11 and the second expandable bag 12 in the filled state or in the empty state can be set according to the requirement. For example, a difference between a thickness of the first expandable bag 11 in the filled state and a thickness of the second expandable bag 12 in the filled state is within a predetermined range, and a difference between a thickness of the first expandable bag 11 in the empty state and a thickness of the second expandable bag 12 in the empty state is also within a predetermined range. Herein, the above-mentioned predetermined ranges merely include zero and values approximating to zero. In this way, no matter whether the expandable cushion massage device is used as the massage apparatus or as the ordinary bed or chair, the height of the expandable cushion massage device is maintained substantially constant, which is conducive to further improvements of user experience. Of course, even if the difference between the above-mentioned thicknesses is the value approximating to zero, other than zero, within the predetermined range, the height of the expandable cushion massage device used as the massage apparatus and the height of the expandable cushion massage device used as the ordinary bed or chair has a relatively small difference therebetween, and the user cannot recognize this difference from perception.

The above-mentioned content describes the service condition of the first expandable bag 11 and the second expandable bag 12 in the expandable cushion massage device provided in the present embodiment. The expandable cushion massage device provided in the present embodiment may be used as the massage mattress, and may also be provided in a whole massage couch, a massage chair, a massage bath room, or massage apparatuses of other types.

It is to be understood that the term “fluid”, which refers to a physical form corresponding to the solid form, is a general term of liquids and gases, and consists of a great number of molecules that continuously perform thermal motion and have no fixed equilibrium position, and basic feature of the fluid lies in that it has no constant shape and has fluidity. In addition, fluid has certain compressibility, specifically, liquid has a relatively small compressibility, and the gas has relatively great compressibility. When the shape of the fluid is changed, certain resistance to motion (i.e. viscosity) will exist between respective layers of the fluid. When the viscosity and compressibility of the fluid is very small, the fluid may be deemed as an ideal fluid, which is an ideal model introduced by human for studying the motion and state of the fluid and a medium for hydraulic transmission and pneumatic transmission. The fluid within the first expandable bag 11 and the second expandable bag 12 of the expandable massage device provided in the present embodiment may be provided to be liquid or gas. When it is provided to be the liquid, the fluid may be water, a mixture of water and other preservatives or be other liquids; and when it is provided to be the gas, the fluid may be common air or other gases.

Further, as shown in FIG. 1, the valve 3 includes a first valve 31 and a second valve 32. The first valve 31 is in connection with the first expandable bag 11, and the second valve 32 is in connection with the second expandable bag 12.

Specifically, in the expandable cushion massage device provided in the present embodiment, the valve 3 comprises two valves, which are a first valve 31 in connection with the first expandable bag 11 and a second valve 32 in connection with the second expandable bag 12, respectively. The two valves are connected with and cooperate with the multi-purpose pump 4, so as to play a role of controlling flowing directions of the fluid within the first expandable bag 11 and the second expandable bag 12 and controlling the fluid within the first expandable bag and the second expandable bag to flow and be blocked. When the massage layer 2 is in the working state, the multi-purpose pump 4 is actuated, and the second valve 32 opens to allow the fluid to enter the second expandable bag 12, while the first valve 31 is closed, and at the same time the first expandable bag 11 is evacuated to completely discharge the fluid therein; and when the massage layer 2 is in the inactive state, the second valve 32 is closed, and at the same time, the second expandable bag 12 is evacuated to completely discharge the fluid therein, while the first valve 31 opens to allow the fluid to flow into the first expandable bag 11. The state of the massage layer 2 is switched between the working state and the inactive state, such that the first expandable bag 11 and the second expandable bag 12 are correspondingly switched between the filled state and the empty state, thereby the overall height of the expandable cushion massage device would not be affected no matter whether the massage layer 2 works or is inactive. In the meantime, the expandable cushion massage device, when in the inactive state, is enabled to have certain elasticity, and may be used as an ordinary bed mattress.

In the present embodiment, the above-mentioned valve 3 may be configured as a three-way valve which is electrically connected and controlled or a one-way valve for electronic control valve connection, so as to achieve the objects of controlling the flowing direction and the flowing of the fluid and flow throttling.

Further, as shown in FIG. 1, the expandable cushion massage device provided in the present embodiment further includes a first pressure sensor 5 in connection with the first expandable bag 11 and a second pressure sensor 6 in connection with the second expandable bag 12.

Further, the first expandable bag 11 and the second expandable bag 12 are each provided with a pressure sensor, namely a first pressure sensor 5 and a second pressure sensor 6, respectively. The function of the pressure sensor is to monitor the pressure in the expandable bag when the fluid is fed in. At the same time, the actuation and stop of the multi-purpose pump 4 is controlled by the pressure sensor, specifically, when the pressure within the expandable bag reaches a predetermined safety threshold, the valve 3 corresponding to the expandable bag is closed and in the meantime the multi-purpose pump 4 is switched off, thus completing the process of feeding the fluid.

Further, as shown in FIG. 1, the expandable cushion massage device provided in the present embodiment further includes a heating layer 111. The heating layer 111 is arranged on the first expandable bag 11 and attached to the first expandable bag 11.

As mentioned above, in the present embodiment, the heating layer 111 is arranged on the first expandable bag 11, and the heating layer 111 can realize the effect of heating through energization, which makes the user feel the heating effect of the massage apparatus while experiencing the massage function of the apparatus, so as to improve the user experience for the expandable cushion massage device.

Further, as shown in FIG. 1, the heating layer 111 further includes a temperature sensor 1111 provided at a side of the heating layer 111.

As mentioned above, the heating layer 111 is further provided with the temperature sensor 1111 in the present embodiment. The heating temperature achieved by the heating layer 111 can be monitored by the temperature sensor 1111, and a range of the heating achieved by the heating layer 111 can be controlled by setting a lowest and a highest threshold of the temperature of the heating layer 111.

Further, as shown in FIG. 2, the first expandable bag 11 further includes a fluid inlet 112 and a fluid outlet 113 arranged at a side of the first expandable bag.

As mentioned above, the expandable cushion massage device provided in the present embodiment is provided with the fluid inlet 112 and the fluid outlet 113, configured for manually inputting and manually discharging the fluid, respectively. Fluid may include gas or a liquid. If the gas is used for the expandable massage device, the expandable bags can be inflated and deflated by the multi-purpose pump 4. If the liquid, e.g. water, is used for the expandable massage device, the liquid may be inputted into the expandable bag through the fluid inlet 112 in advance, and the flowing directions of the liquid within the expandable bags are guided via the multi-purpose pump 4, such that the expandable bags can be switched between the filled state and the empty state. When the internal fluid needs to be manually discharged or the expandable bags need to be washed, manual operations are required to be performed via the fluid inlet 112 and the fluid outlet 113.

Further, as shown in FIG. 2, the fluid outlet 113 further includes an output pump 1131 provided at the outlet end of the fluid outlet 113.

As mentioned above, the fluid outlet 113 in the present embodiment is provided with an output pump 1131, which may increases the discharge velocity during the discharge of the fluid within the expandable bag. The output pump 1131 can be provided as a water pump or an exhaust pump according to the specific kind of the fluid within the expandable bag.

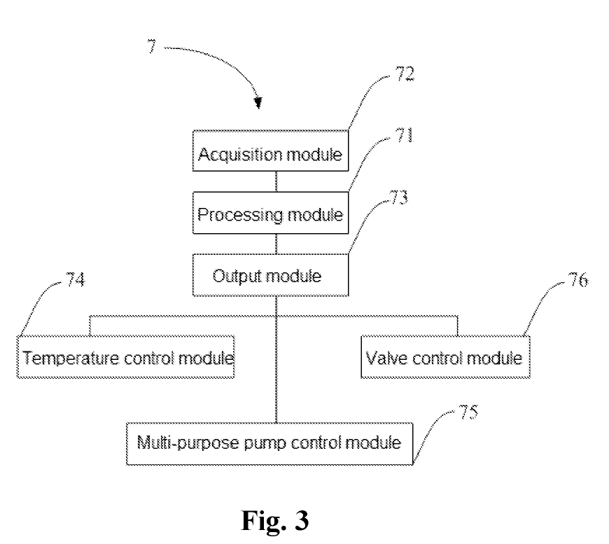

Further, as shown in FIG. 2, the expandable cushion massage device provided in the embodiment further includes a central control device 7. As shown in FIG. 3, the central control device 7 includes a processing module 71, an acquisition module 72 and an output module 73. The temperature sensor 1111, the first pressure sensor 5 and the second pressure sensor 6 are all in electrical connection with the acquisition module 72.

In the above, the acquisition module 72 is configured to acquire data outputted by the temperature sensor 1111 and the pressure sensor as mentioned above. The processing module 71 is configured to process and identify the data acquired by the acquisition module 72. The output module 73 is configured to output the data processed and identified by the processing module 71.

Further, as shown in FIG. 3, the central control device 7 further includes a temperature control module 74, a multi-purpose pump control module 75 and a valve control module 76. The temperature control module 74, the multi-purpose pump control module 75 and the valve control module 76 are all in electrical connection with the output module 73. Moreover, the temperature control module 74 is in electrical connection with the above mentioned heating layer 111, the multi-purpose pump control module 75 is in electrical connection with the above mentioned multi-purpose pump 4, and the valve control module 76 is in electrical connection with the above mentioned valve 3.

In the above, the temperature control module 74 is configured to receive a first instruction outputted by the output module 73 and control the heating layer 111 according to the first instruction. The multi-purpose pump control module 75 is configured to receive a second instruction outputted by the output module 73 and control the multi-purpose pump 4 according to the second instruction. The valve control module 76 is configured to receive a third instruction outputted by the output module 73 and control the first valve 31 and the second valve 32 according to the third instruction.

As mentioned above, the expandable massage device provided in the present embodiment is provided with the central control device 7. The central control device 7 includes the processing module 71, the acquisition module 72, the output module 73, the temperature control module 74, the multi-purpose pump control module 75 and the valve control module 76. After the data sent back by the sensor is acquired, the processing module 71 processes the data, and respective instructions are outputted to the temperature control module 74, the multi-purpose pump control module 75 and the valve control module 76, so as to control the actuation and stop on the corresponding elements.

The above mentioned is the central control device 7 provided in the present embodiment. Specifically, the central control device 7 may be provided as an operation controller of a wired terminal or a wireless terminal. The operation controller of the wired terminal may be configured as an operation desk and mounted at any position on the massage apparatus in the present embodiment, and may also be manufactured as a handle or any other forms such as a simple control lever, and the like. The wireless terminal can be connected and controlled via a mobile apparatus, and in the meantime may also share various data of the massage apparatus, such as massage time, various health indices of the body, heating or operating parameters of the apparatus, through social media, or form a ranking list of the data or the like.

Further, the massage layer 2 includes a main massaging device 21, a moving device 22 and a floating device 23. As shown in FIG. 2, in the present embodiment, the floating device 23 is arranged at a lower end of the main massaging device 21 and configured to enable the main massaging device 21 to float up and down. The moving device 22 is arranged at a lower end of the floating device 23 and configured to enable the main massaging device 21 to move back and forth in a preset rail.

As mentioned above, the expandable cushion massage device includes a massage layer 2 arranged between the first expandable bag 11 and the second expandable bag 12. The moving device 22 and the floating device 23 of the massage layer 2 are configured to move in a predetermined direction and simultaneously float up and down, thereby achieving a massaging effect.

In summary, the expandable massage device provided in the present embodiment not only can be used as the massage apparatus with the massage function, but also can be used as a piece of furniture such as a bed or a chair providing a relatively comfortable use for the user, thus realizing the function enabling the device to be multi-purpose, and achieving the object of implementing massage fitness and rest on the same apparatus, which are convenient for the user and improve the user experience. In addition, the second expandable bag 12 in the filled state can raise the massage layer 2, such that the massage layer acts on a certain body part of the user and massage the certain body part, and it is conducive to compensate a height difference of the expandable massage device caused by the state switching of the first expandable bag 11, which is further convenient for the user and improves the user experience.

It shall be clarified that in other embodiments of the present invention, the expandable cushion layer of the expandable cushion massage device may also not include the above-mentioned second expandable bag 12. In such case, the first expandable bag 11 is arranged above the massage layer 2, and the first expandable bag 11 is in connection with the multi-purpose pump 4 via the valve 3. In a situation where the massage layer 2 is in the operating state, the first expandable bag 11 is evacuated via the valve 3 to completely discharge the fluid therein, leading to an empty state. In a situation where the massage layer 2 is in an inactive state, the first expandable bag 11 is filled with the fluid via the multi-purpose pump 4, leading into a filled state. When the massage layer 2 is in the operating state and the first expandable bag 11 is in the empty state, the expandable cushion massage device can be used by the user as the massage apparatus. When the massage layer 2 is in the inactive state and the first expandable bag 11 is in the filled state, the expandable cushion massage device can be used by the user as the ordinary bed or chair, specifically, the first expandable bag 11 in the filled state can effectively avoid that the relatively rigid massage layer 2 directly acts on the human body, which assures the comfortableness when the expandable cushion massage device is used as the ordinary bad or chair, or the like.

Furthermore, an embodiment of the present invention further provides a method for controlling the expandable cushion massage device. The expandable cushion massage device includes an expandable cushion layer, a massage layer, a valve and a multi-purpose pump. The expandable cushion layer includes a first expandable bag and a second expandable bag, with the first expandable bag being arranged above the massage layer, the second expandable bag being arranged below the massage layer, and the first expandable bag and the second expandable bag are each in connection with the multi-purpose pump via the valve. The control method includes Step S101 and Step S102 as follows.

Step S101, in a situation where the massage layer is in an operating state, the multi-purpose pump is controlled to fill the second expandable bag with the fluid to form a filled state, and the valve is controlled to exhaust the fluid within the first expandable bag to form an empty state.

Step S102, in a situation where the massage layer is in an inactive state, the multi-purpose pump is controlled to fill the first expandable bag with the fluid to form a filled state, and the valve is controlled to exhaust the fluid within the second expandable bag to form an empty state.

It shall be understood that although the present description is described based on the embodiments, not every embodiment only includes one independent technical solution. The description is made in such way merely for the purpose of clarity, and a person skilled in the art would deem the description as a whole, and the technical solutions of the respective embodiments may also be combined with each other in an appropriate way, so as to form further embodiments that could be understandable for a person skilled in the art.

The applicant asserts that the series of detailed description of the present application illustrated above is merely specific description for feasible embodiments of the present application, however, the present application is not limited to the above-mentioned detailed process apparatuses and processes. Moreover, it does not mean that the present application is implementable only depending on the above-mentioned detailed apparatuses and process. It should be clear for a person skilled in the art that any improvements of the present application, equivalent substitutions of respective raw materials for the products of the present application and addition of auxiliary components as well as selections of specific implementations and the like all fall within the scope of protection and disclosure of the present application.

### INDUSTRIAL APPLICABILITY

The expandable massage device provided in the present embodiment not only can be used as the massage apparatus with the massage function, but also can be used as a piece of furniture such as a bed or a chair providing a relatively comfortable use for the user, realizing the function enabling the device to be multi-purpose and achieving the object of implementing massage fitness and rest on the same apparatus, which are convenient for the user and improve the user experience.

1. An expandable cushion massage device, comprising an expandable cushion layer, a massage layer, a valve and a multi-purpose pump,
wherein the expandable cushion layer comprises a first expandable bag and a second expandable bag, and the first expandable bag and the second expandable bag are provided at an upper end and a lower end of the massage layer, respectively;
the first expandable bag and the second expandable bag are in connection with the multi-purpose pump via the valve;
when the massage layer is in an operating state, the second expandable bag is filled with fluid via the multi-purpose pump to be expanded, and the first expandable bag is evacuated via the valve to completely discharge fluid; and
when the massage layer is in an inactive state, the first expandable bag is filled with the fluid through the multi-purpose pump to be expanded, and the second expandable bag is evacuated via the valve to completely discharge fluid.

2. The expandable cushion massage device according to claim 1, wherein the valve comprises a first valve and a second valve, the first valve is in connection with the first expandable bag, and the second valve is in connection with the second expandable bag.

3. The expandable cushion massage device according to claim 1, further comprising a first pressure sensor and a second pressure sensor, wherein the first pressure sensor is in connection with the first expandable bag, and the second pressure sensor is in connection with the second expandable bag.

4. The expandable cushion massage device according to claim 2, further comprising a first pressure sensor and a second pressure sensor, wherein the first pressure sensor is in connection with the first expandable bag, and the second pressure sensor is in connection with the second expandable bag.

5. The expandable cushion massage device according to claim 1, further comprising a heating layer, wherein the heating layer is provided on the first expandable bag.

6. The expandable cushion massage device according to claim 2, further comprising a heating layer, wherein the heating layer is provided on the first expandable bag.

7. The expandable cushion massage device according to claim 3, further comprising a heating layer, wherein the heating layer is provided on the first expandable bag.

8. The expandable cushion massage device according to claim 5, wherein the heating layer is attached to the first expandable bag.

9. The expandable cushion massage device according to claim 5, wherein the heating layer further comprises a temperature sensor provided at a side of the heating layer.

10. The expandable cushion massage device according to claim 1, wherein the first expandable bag further comprises a fluid inlet provided at a side of the first expandable bag.

11. The expandable cushion massage device according to claim 2, wherein the first expandable bag further comprises a fluid inlet provided at a side of the first expandable bag.

12. The expandable cushion massage device according to claim 3, wherein the first expandable bag further comprises a fluid inlet provided at a side of the first expandable bag.

13. The expandable cushion massage device according to claim 10, wherein the first expandable bag further comprises a fluid outlet provided at a side of the first expandable bag.

14. The expandable cushion massage device according to claim 13, wherein the fluid outlet further comprises an output pump provided at an outlet end of the fluid outlet.

15. The expandable cushion massage device according to claim 1, wherein a difference between a thickness of the first expandable bag in a filled state and a thickness of the second expandable bag in a filled state is within a predetermined range, and a difference between a thickness of the first expandable bag in an empty state and a thickness of the second expandable bag in an empty state is also within a predetermined range.

16. The expandable cushion massage device according to claim 9, further comprising a central control device, a first pressure sensor in connection with the first expandable bag and a second pressure sensor in connection with the second expandable bag, wherein the central control device comprises a processing module, an acquisition module and an output module, and the temperature sensor, the first pressure sensor and the second pressure sensor are all in electrical connection with the acquisition module;
the acquisition module is configured to acquire data from the temperature sensor and the pressure sensor;
the processing module is configured to process and identify the data acquired by the acquisition module; and
the output module is configured to output the data processed and identified by the processing module.

17. The expandable cushion massage device according to claim 16, wherein the central control device further comprises a temperature control module, a multi-purpose pump control module and a valve control module, the temperature control module, the multi-purpose pump control module and the valve control module are all in electrical connection with the output module, the temperature control module is in electrical connection with the heating layer, the multi-purpose pump control module is in electrical connection with the multi-purpose pump, and the valve control module is in electrical connection with the valve;
the temperature control module is configured to receive a first instruction outputted by the output module and control the heating layer according to the first instruction;
the multi-purpose pump control module is configured to receive a second instruction outputted by the output module and control the multi-purpose pump according to the second instruction; and
the valve control module is configured to receive a third instruction outputted by the output module and control the valve according to the third instruction.

18. The expandable cushion massage device according to claim 1, wherein the massage layer comprises a main massaging device, a moving device and a floating device;
the floating device is provided at a lower end of the main massaging device and configured to drive the main massaging device to float up and down; and
the moving device is provided at a lower end of the floating device and configured to drive the main massaging device to move back and forth in a preset rail.

19. An expandable cushion massage device, comprising an expandable cushion layer, a massage layer, a valve and a multi-purpose pump;
the expandable cushion layer comprises a first expandable bag, with the first expandable bag provided above the massage layer;
the first expandable bag is in connection with the multi-purpose pump via the valve;
in a situation where the massage layer is in an operating state, the first expandable bag is evacuated to completely discharge the fluid through the valve, leading to an empty state; and
in a situation where the massage layer is in an inactive state, the first expandable bag is filled with fluid via the multi-purpose pump, leading to a filled state.

20. A method for controlling an expandable cushion massage device, wherein the expandable cushion massage device comprises an expandable cushion layer, a massage layer, a valve and a multi-purpose pump, the expandable cushion layer comprises a first expandable bag and a second expandable bag, with the first expandable bag being provided above the massage layer, the second expandable bag being provided below the massage layer, and the first expandable bag and the second expandable bag being each in connection with the multi-purpose pump via the valve; and the method comprises:
controlling, in a situation where the massage layer is in an operating state, the multi-purpose pump to fill the second expandable bag with fluid to form a filled state, and controlling the valve to exhaust the fluid within the first expandable bag to form an empty state;
controlling, in a situation where the massage layer is in an inactive state, the multi-purpose pump to fill the first expandable bag with the fluid to form a filled state, and controlling the valve to exhaust the fluid within the second expandable bag to form an empty state.
